(19) United States
(12) Patent Application Publication
(10) Pub. No.: US 2012/0282417 A1
(43) Pub. Date: Nov. 8, 2012

(54) METHOD FOR PREPARING A METALLIZED POLYMER SUBSTRATE

(75) Inventors: Alexandre Garcia, Ivry Sur Seine (FR); Thomas Berthelot, Les Ulis (FR)

(73) Assignee: Commissariat a l'energie atomique et aux energies alternatives, Paris (FR)

(21) Appl. No.: 13/514,963

(22) PCT Filed: Dec. 10, 2010
(86) PCT No.: PCT/EP2010/069411

§ 371 Date: Jul. 17, 2012

(30) Foreign Application Priority Data
Dec. 10, 2009 (FR) 09 58851

(51) Int. Cl. B05D 1/18; B05D 3/02; B05D 3/06; B05D 3/12; B05D 3/10

(52) U.S. Cl. 427/576; 427/443.1; 427/290; 427/307; 427/316

(57) ABSTRACT

A method for coating a surface of a substrate in (co)polymer with a metal material is provided. The method may comprise the successive steps of (a) subjecting the surface to an oxidizing treatment by a chemical reaction of the Fenton type in the presence of at least one precursor of the metal material and (b) transforming the precursor into the metal material.

### TECHNICAL FIELD

The invention belongs to the technical field of surface coatings and more particularly to the technical field of metallization of surfaces.

Thus, the present invention relates to a simplified metallization method applying polymeric substrates.

### STATE OF THE PRIOR ART

Generally, metallization consists in coating the surface of a part with a thin metal layer.

Metallization of a part in plastic materials is notably used in fields, such as automobiles and boats where certain accessories in (co)polymer are coated with chromium; the electronic industry, home electrical appliances and lamps; cosmetics and fashion accessories; optics and watch-making; etc. Therefore the development of a method for metallization of a surface in plastic materials and more generally in polymers, is therefore of great interest.

Metallization of polymers is a method which has been developed for more than 50 years. It involves alternative techniques to those used for conducting substrates.

Presently, metallization of polymers is generally carried out in 3 steps.

The first step is a step for modifying the surface, which first of all provides surface roughness in order to improve the adherence of the metal layer by mechanical anchoring.

This modification also allows an increase in the wettability of the surface of the polymer, notably by providing hydrophilic groups generally incorporating oxygen atoms or nitrogen atoms and this in order to facilitate activation of the surface. Indeed, the polymer must have groups promoting adsorption of the activating metal agent.

For example, if the metal agent is palladium, chemisorption of the latter is only possible on nitrogen-containing elements [1]. Regardless of the pretreatment, roughness and provision of C—O and/or C—N bonds at the surface of the polymer to be metallized are mandatory.

The second step is a step for activating the surface, which consists in depositing metal particles at the surface of the modified polymer. These particles subsequently play the role of a catalyst for metallization. Thus, metal cations which will subsequently be reduced must be maintained at the surface of the polymer.

The last step applies a metallization bath into which the activated polymers are immersed. In this bath, metal growth is catalyzed by the metal particles deposited in the previous step. The metallization bath is a stable solution containing at least one metal cation and its complexing agent, a reducing agent and a stabilizer, generally in an alkaline medium.

Methods notably used industrially consist in oxidizing the surface to be metallized and then adsorbing on the latter, palladium via the tin/palladium colloid, which corresponds to the activation step. Subsequently to the latter, an acceleration step is applied, allowing removal of tin, thus promoting the activity of the precursor of the metal layer, which in this case is palladium. Trace amounts of tin may actually induce metal growth in undesired locations. The acceleration step is followed by a step in the presence of a metallization bath as defined earlier.

This method is notably described in patent application CA 1,203,720 [2]. However, the method, subject-matter of this application, does not have an oxidation of the Fenton type in the presence of precursors of the metal material. Indeed, the latter is not present during the step applying hydrogen peroxide.

Taking into account the diversity of the fields in which metallization of the polymers and notably of plastics is used, and economical challenges, there exists a real need for a simplified metallization method and therefore with a lower cost as compared with methods presently used.

### SUMMARY OF THE INVENTION

With the present invention it is possible to meet this expectation and to solve the technical problems of the metallization methods of the state of the art.

Indeed, with the work of the inventors, it was possible to develop a metallization method in which several steps of the conventional methods for metallization of polymers are suppressed since the method of the invention consists of depositing and maintaining metal cations at the surface of a polymer at the same time as its surface oxidation.

More particularly, the present invention relates to a method for coating the surface of a substrate in (co)polymer with a metal material comprising the successive steps of:

a) subjecting said surface to an oxidizing treatment by a chemical reaction of the Fenton type in the presence of at least one precursor of said metal material;

b) transforming said precursor into said metal material.

By <<coating with a metal material>>, is meant within the scope of the present invention, a substrate with a surface coated with a thin layer, typically of a few nanometers to several micrometers, of a metal and/or of a metal oxide. This thin layer may cover all or part of the surface of the substrate. The thereby coated substrate may be called <<a metallized substrate>>.

Among the metallized substrates, a distinction may notably be made between substrates metallized only with a metal or only with a metal oxide, and substrates metallized by both types of metal entities.

The substrate according to the present invention may be of any size and shape. Indeed, the size of the applied substrate within the scope of the present invention may be nanometric, micrometric, millimetric or metric. Thus, the present invention applies, as non-limiting examples, to a substrate which may be selected from the group consisting of a nanoparticle, a microparticle, a button, a plug of cosmetic products, an electronic element, a door handle, a home electrical appliance, glasses, a decorative object such as a lamp, a vehicle body element, etc.

By <<surface of a substrate in (co)polymer>>, is not only meant a substrate in (co)polymer but also a substrate for which only the surface is in (co)polymer, the remainder of the substrate may be in any material.

By <<in (co)polymer>>, is meant within the scope of the present invention a substrate or a surface essentially formed by a single (co)polymer or several different (co)polymers.

By <<essentially formed>>, is meant within the scope of the present invention, a substrate or a surface for which at least 50%, at least 60%, at least 70%, at least 80%, at least 90%, at least 95% and/or at least 98% of the constituents expressed by weight are (co)polymer(s).

Advantageously, the substrate or the surface of the substrate is only formed by one or several (co)polymer(s).

Alternatively, the substrate or the surface of the substrate, comprises, in addition to (co)polymer(s), at least one element selected from the group consisting of fillers, plasticizers and additives. This(these) additional element(s) is(are) advantageously incorporated and/or dispersed into the polymer material.

As a reminder, a plastic or plastic material is formed with at least one (co)polymer advantageously having a degree of polymerization of more than 3,000 and with at least one additive. Therefore, the substrate or the surface of the substrate in polymer applied within the scope of the present invention comprises substrates or substrate surfaces in plastic or in plastic material.

Mineral fillers such as silica, talc, glass fibers or beads or organic fillers such as cereal flour, or cellulose paste are generally used for reducing the cost and for improving certain properties such as the mechanical properties of the polymeric material. Additives are mainly used for improving a specific property of the polymeric material, said property may be cross-linking, sliding, resistance to degradation, to fire and/or to bacterial and fungal attacks.

Any natural, artificial, synthetic, thermoplastic, thermosetting, thermostable, elastomeric, linear (i.e. one-dimensional, linear or branched) and/or three-dimensional polymer may be used within the scope of the present invention. As non-limiting examples of natural polymers, mention may be made of sugars.

Advantageously, the polymer applied within the scope of the present invention is a thermoplastic (co)polymer selected from the group consisting of:
a polyolefin such as a polyethylene, a polypropylene, an ethylene/propylene copolymer, a polybutylene, a polymethylpentene, an ethylene/vinyl acetate copolymer and ethylene/vinyl alcohol copolymer, one of their copolymers, of their mixtures and of their combinations;
a polyester such as a polyethylene terephthalate optionally modified by glycol, a polybutylene terephthalate, a polylactide, a polycarbonate, one of their copolymers, of their mixtures and of their combinations;
a polyether such as poly(oxymethylene), a poly(oxyethylene), a poly(oxypropylene), a poly(phenylene ether), one of their copolymers, of their mixtures and of their combinations;
a vinyl polymer such as a polyvinyl chloride optionally chlorinated, a poly(vinyl alcohol), a poly(vinyl acetate), a poly(vinyl acetal), a poly(vinyl formal), a poly(vinyl fluoride), a poly(vinyl chloride/vinyl acetate), one of their copolymers, of their mixtures and of their combinations;
a vinylidene polymer such as a poly(vinylidene chloride), a poly(vinylidene fluoride), one of their copolymers, of their mixtures and of their combinations;
a styrene polymer such as a polystyrene, a poly(styrene/butadiene), a poly(acrylonitrile/butadiene/styrene, a poly(acrylonitrile/styrene), a poly(acrylonitrile/ethylene/propylene/styrene), a poly(acrylonitrile/styrene/acrylate), one of their copolymers, of their mixtures and of their combinations;
a (meth)acrylic polymer such as a polyacrylonitrile, a poly(methyl acrylate), a poly(methyl methacrylate), one of their copolymers, of their mixtures and of their combinations;
a polyamide such as a poly(caprolactam), a poly(hexamethylene adipamide), a poly(lauroamide), a poly(ether-block-amide), a poly(metaxylylene adipamide), a poly(metaphenylene isophthalamide), one of their copolymers, of their mixtures and of their combinations;
a fluorinated polymer (or polyfluoroethene) such as polytetrafluoroethylene, polychlorotrifluoro-ethylene, perfluorinated poly(ethylene/propylene), poly(vinylidene fluoride), one of their copolymers, of their mixtures and of their combinations;
a cellulose polymer such as a cellulose acetate, a cellulose nitrate, a methylcellulose, a carboxymethylcellulose, one of their copolymers, of their mixtures and of their combinations;
a poly(arylenesulfone) such as a polysulfone, a polyethersulfone, a polyarylsulfone, one of their copolymers, of their mixtures and of their combinations;
a polysulfide such as a poly(phenylene sulfide);
a poly(arylether)ketone such as a poly(ether ketone), a poly(ether ether ketone), a poly(ether ketone ketone), one of their copolymers, of their mixtures and of their combinations;
a polyamide-imide;
a poly(ether)imide;
a polybenzimidazole;
a poly(indene/cumarone);
a poly(paraxylylene);
one of their copolymers, one of their mixtures and one of their combinations.

Alternatively, the (co)polymer applied within the scope of the present invention is a thermosetting (co)polymer selected from the group consisting of an aminoplast such as urea-formol, melamine-formol, melamine-formol/polyesters, one of their copolymers, of their mixtures and of their combinations; a polyurethane; an unsaturated polyester; a polysiloxane; a formophenolic resin, an epoxide, allylic or vinyl ester resin; an alkyd; a polyurea; a polyisocyanurate; a poly(bismaleimide); a polybenzimidazole; a polydicyclopentadiene; one of their copolymers, one of their mixtures and one of their combinations.

Complementary information on the polymers which may be used within the scope of the present invention is accessible in the article of Naudin, 1995 [3].

As non-limiting examples of this (co)polymer which may be used within the scope of the present invention, mention may be made of acrylonitrile/butadiene/styrene (ABS), acrylonitrile/butadiene/styrene/polycarbonate (ABS/PC), a polyamide (PA) such as nylon, polyamine, poly(acrylic acid), polyaniline and polyethylene terephthalate (PET).

Prior to step (a) of the method according to the invention, the substrate to be metallized does not have any precursor of the metal material adsorbed at the surface.

By <<oxidizing treatment>>, is meant within the scope of the present invention a treatment aiming at oxidizing the surface of the applied substrate. This oxidation modifies the surface of the substrate notably by binding and/or introducing thereon groups rich in oxygen and notably polar and/or hydrophilic groups such as groups of the carboxylic (—COOH), hydroxyl (—OH), alkoxyl (—OR) (with R being as defined hereafter), carbonyl (—C═O), percarbonic (—C—O—OH) and sometimes amide (—CONH) type. Such an oxidizing treatment is also capable of increasing the hydrophilicity of the surface of the applied substrate.

This treatment is based on the use of various reagents in order to generate at the surface of the (co)polymer forming the surface of the substrate and/or the substrate, a surface oxidation allowing better adhesion and/or a better hold at the surface of the substrate, of the precursor of a metal material present during the oxidizing treatment. This adhesion and/or this hold apply a chelation (or complexation) between the precursor of metal material and groups present on the oxidized surface. All or part of the precursor of the metal material notably remains at the surface of the (co)polymer and may subsequently be reduced.

Advantageously, step (a) of the method according to the present invention is applied at a temperature of less than 60° C., notably comprised between 5° C. and 50° C. and, in particular, comprised between 10° C. and 40° C. Step (a) according to the invention is achieved in a more particular embodiment at room temperature. By <<room temperature>>, is meant a temperature of 20° C.±5° C.

The oxidizing treatment applied during step (a) is based on the chemical reaction of Fenton (1894). This oxidizing treatment may therefore be designated as an oxidizing treatment by chemical reaction of the Fenton type. As a reminder, Fenton's chemical reaction consists in an oxidation of hydrogen peroxide in an acid medium by ferrous ions represented by the following reaction scheme:

Fe²⁺+H₂O₂→Fe³⁺+.OH+OH⁻

This reaction generates hydroxyl radicals (.OH) which are highly reactive notably towards plastic surfaces, the ferrous ions playing the role of a precursor of the metal material.

The generalized Fenton chemical reaction applied to the oxidizing treatment of step (a) of the method of the present invention consists in putting said surface of the substrate in contact with a solution containing at least one precursor of the metal material and a compound of formula ROOR in which R represents a hydrogen, an alkyl group comprising from 1 to 15 carbon atoms, an acyl group —COR′ with R′ representing an alkyl group comprising from 1 to 15 carbon atoms or an aroyl group —COAr with Ar representing an aromatic group comprising from 6 to 15 carbon atoms.

By <<alkyl group comprising from 1 to 15 carbon atoms>>, is meant a linear, branched or cyclic alkyl group, optionally substituted, comprising from 1 to 15 carbon atoms, notably from 1 to 10 carbon atoms and, in particular from 2 to 6 carbon atoms and optionally a heteroatom such as N, O, F, Cl, P, Si, Br or S.

By <<aromatic group comprising from 6 to 15 carbon atoms>>, is meant within the scope of the present invention, an aromatic or heteroaromatic group optionally substituted, consisting of one or several aromatic or heteroaromatic groups each including from 3 to 10 atoms, the heteroatom(s) may be N, O, P or S.

By <<substituted>>, within the scope of the present invention, is meant an alkyl or aromatic group, mono- or poly-substituted with a linear or branched alkyl group, comprising from 1 to 4 carbon atoms, with an amine group, with a carboxylic group and/or with a nitro group.

Radicals .OR with R as defined earlier, are obtained by cleaving the peroxide ROOR with the precursor of the metal material. The reaction during step (a) of the method of the present invention may be represented by the following reaction scheme:

Zⁿ⁺+ROOR→Z⁽ⁿ⁺¹⁾⁺+.OR+OR⁻

with Z representing the precursor of the metal material and n representing an integer comprised between 1 and 7 and notably between 1 and 5. The integer n is advantageously selected from the group consisting of 1, 2, 3, 4 and 5.

The precursor(s) of the metal material applied during step (a) of the method according to the invention, play(s) a role of catalyst(s) of metal growth and therefore of metallization of the surface of the substrate. The precursor(s) of the metal material is(are) advantageously metal cation(s) notably selected from noble metals of Group IB or Group VIII. More particularly, the precursor(s) of the metal material is(are) selected from the group consisting of copper, silver, gold, iron, ruthenium, osmium, cobalt, rhodium, iridium, nickel, palladium and platinum ions.

The precursors of the metal material are present in the solution comprising at least one precursor of the metal material and a compound of formula ROOR at a concentration comprised between 0.05 and 5 M, notably between 0.1 and 3 M and, in particular, between 0.5 and 2.5 M. The solution comprising at least one precursor of the metal material and a compound of formula ROOR further comprises counter-ions such as tetrafluoroborate, sulfate, bromide, fluoride, iodide, nitrate, phosphate or chloride ions.

The compound of formula ROOR is present in the solution comprising at least one precursor of the metal material and a compound of formula ROOR at a concentration comprised at 5×10⁻⁴ M and 5 M, notably, between 0.1 and 3 M and, in particular between 0.5 and 2.5 M.

The solution comprising at least one precursor of the metal material and a compound of formula ROOR is advantageously an acid solution. By “acid solution”, is meant a solution for which the pH is less than 7, notably comprised between 2 and 4 and, in particular on the order of 3 (i.e. 3±0.5). This solution further comprises sulfuric acid and notably at a concentration comprised between 0.05 and 50 mM, in particular between 0.1 and 10 mM and more particularly on the order of 1 mM (i.e. 1±0.25 mM).

The duration of the treatment with a chemical reaction of the Fenton type may be variable. As non-limiting examples, this duration is advantageously comprised between 5 mins and 5 h, notably between 10 mins and 3 h, in particular between 15 mins and 2 h and more particularly, on the order of 25 mins (i.e. 25±5 min).

It may be necessary, after the oxidizing treatment by a chemical reaction of the Fenton type, to provide other precursors of the metal material and this by putting the surface of the substrate and/or the substrate in contact with a chelation bath under conditions well known to one skilled in the art.

Alternatively, the precursors of the metal material are only provided by the solution used during the Fenton reaction i.e. the solution applied during step (a) of the method of the invention.

Within the scope of the present invention, the Fenton reaction is used for oxidizing the surface of the substrate to be metallized but also for adsorbing the metal cations which subsequently act as precursors of the metal layer deposited by electroless deposition.

Step (b) of the method according to the present invention is a step well-known to one skilled in the art specialized in the metallization of materials since it consists in transforming the precursor of the metal material into said metal material.

Any technique allowing such a transformation may be used within the scope of the present invention.

Advantageously, this transformation step has the successive sub-steps of

b₁) optionally reducing said precursor of said metal material present at the surface of said substrate;

b₂) putting into contact said precursor optionally reduced following step (b₁) in a solution containing at least one ion of the metal material.

Any technique allowing reduction of the precursor of the metal material may be used within the scope of step (b₁) of the method according to the present invention.

Advantageously, this reduction step is a chemical reduction in a single step. This preferred alternative consists in putting the surface of the substrate on which is(are) found the precursor(s) of the metal material in contact with a reducing solution S_{R}.

Advantageously, the reducing solution S_{R} is basic. The reducing solution S_{R} comprises a reducing agent, notably selected from the group consisting of sodium borohydride (NaBH₄), dimethylamineborane (DMAB-H(CH₃)₂NBH₃) and hydrazine (N₂H₄).

When the reducing agent is NaBH₄, the pH of the reducing solution S_{R} is neutral or basic, while for DMAB, the pH of the solution S_{R} is basic. When the solution S_{R} is basic, a solvent which is advantageously used, is NaOH and notably at a concentration comprised between 10⁻⁴ M and 5 M, notably between 0.05 and 1 M and, in particular, on the order of 0.1 M (i.e. 0.1 M±0.01 M).

The reducing agent is present in the reducing solution S_{R} at a concentration comprised between 10⁻⁴ and 5 M, notably between 0.01 and 1M and, in particular on the order of 0.3 M (i.e. 0.3 M±0.05 M).

The reducing step (b₁) may be carried out at a temperature comprised between 20° C. and 100° C., notably between 30° C. and 70° C. and, in particular, of the order of 50° C. (i.e. 50° C.±5° C.).

Further, the reduction step (b₁) may last for between 30 s and 1 h, notably between 1 and 30 mins and, in particular between 2 and 20 mins.

The precursors of the metal material, reduced following step (b₁) of the method according to the invention, in majority have a degree of oxidation of 0. Thus, metallization may then occur by immersion in a metallization and growth bath on the particles of precursors at a degree of oxidation of 0.

It should be noted that this reduction step (step (b₁)) may be optional. Indeed, in certain cases, the precursor of the metal material may be reduced during the putting into contact with the solution containing at least one ion of the metal material during step (b₂) without a preliminary reduction step being necessary. Indeed, if the precursor of the metal material has an oxidation/reduction potential greater than that of the metal deposited by electroless deposition, the precursor of the metal material may be, in a first phase, reduced during the putting into contact with the ion of the metal material before metal growth is initiated.

Step (b₂) therefore consists in putting into contact said precursor reduced following step (b₁) in a solution containing at least one ion of the metal material. The solution containing one ion of the metal material, hereafter designated as S_{M} corresponds to a metallization bath well-known to one skilled in the art, just like its components.

As an example, the solution S_{M} containing at least one ion of the metal material applied in step (b₂) comprises ions of the metal material, an agent complexing the ions of the metal material, a reducing agent and a pH regulator. Advantageously, said solution S_{M} is an aqueous solution. Further, several metallization solutions are available commercially.

The ion(s) of the metal material applied within the scope of the present invention may be any ion of a metal material. The present invention more particularly relates to the ions of a transition metal. Advantageously, the ion(s) of the metal material according to the invention is(are) selected from the group consisting of Ag⁺, Ag²⁺, Ag³⁺, Au⁺, Co²⁺, Cu⁺, Cu²⁺, Fe²⁺, Ni²⁺, Pd⁺, and Pt⁺.

In the solution S_{M}, the ion(s) of the metal material is(are) associated with an anionic counter-ion. As anionic counter-ions which may be used, mention may be made of a chloride, bromide, fluoride, iodide, sulfate, nitrate, phosphate, acetate ion and of any organic or inorganic acid salt ion.

The agent complexing the ions of the metal material is necessary for compensating the loss of solubility of these ions under the basic conditions used and for avoiding their precipitation. Such a complexing agent is notably selected from organic acids and their salts such as tartaric acid, EDTA or EDTP.

The reducing agent advantageously applied may notably be formaldehyde, DMAB or H₂PO₂. One skilled in the art is aware of different ion pairs of the metal material/reducing agent which may be used within the scope of the present invention. Also, depending on the particular selected pair, one skilled in the art is aware of the pH and temperature conditions for the solution S_{M}, to be applied.

As an example in a solution S_{M} containing copper ions, the reducing agent advantageously applied under basic conditions is formaldehyde in an amount comprised between 0.1 and 5% (v/v) relatively to the total volume of the solution S_{M}. By <<basic conditions>>, is meant a solution for which the pH is comprised between 10 and 14 and notably between 12 and 13, such a pH is obtained by using NaOH as a pH regulator.

As an example in a solution S_{M} containing copper ions, the metallization step (b₂) may be carried out at a temperature comprised between 20° C. and 80° C., notably between 30° C. and 60° C. and in particular, on the order of 40° C. (i.e. 40° C.±5° C.).

Further, the metallization step (b₂) may last for between 1 min and 1 h, notably between 5 and 45 mins and in particular between 10 and 30 mins.

The metallization of the surface of the substrate i.e. the presence of a thin layer of metal material at the surface of the substrate may easily be checked, typically visually and notably with the naked eye.

Within the scope of the present invention, prior to step (a) of the method, the surface of the substrate to be metallized may optionally undergo different pretreatments. These pretreatments may be conventional treatments from the field of metallization of surfaces such as degreasing or polishing.

Alternatively, the surface of the substrate may optionally be subject, prior to the step (a) of the method according to the invention, to a treatment capable of increasing its hydrophilicity and/or its roughness, said treatment being selected from the group formed by sanding, abrasion, chemical treatment with a pickling bath, a flame treatment, a corona effect treatment and a plasma treatment and combinations thereof.

Indeed, the treatment applied during step (a) does not provide any additional roughness to the surface of the substrate, which may be checked by an AFM measurement. Also, depending on the initial roughness of the (co)polymer forming the surface of the substrate or the substrate, a pretreatment preceding step (a) in order to provide surface roughness, has to be carried out.

Further, it may be necessary to increase the hydrophilicity of the (co)polymer forming the surface of the substrate or the substrate to be treated. Certain (co)polymers already have nitrogen-containing or oxygen-containing groups such as polyacrylic acid, polyanilines and polyamides. If these oxygens or nitrogens are accessible at the surface of the substrate to be metallized, the step providing hydrophilicity is not mandatory.

Depending on the polymer, the surface roughness with or without provision of hydrophilic functions may thus be provided by a mechanical, chemical pretreatment or via a dry route and will be for certain cases, accompanied by surface oxidation.

A mechanical pretreatment of the surface to be treated consists in sanding or abrasion with sandpapers with smaller or larger grains. It by no means changes the chemical composition of the surface and therefore does not oxidize the surface of the (co)polymer forming the surface of the substrate or the substrate to be treated. Further, it is not always efficient and only remains possible in the case of substrates with a suitable size such as substrates appearing as large planar parts.

A chemical (acid/base) pretreatment (or a chemical treatment with a pickling bath) is based on putting the surface to be treated in contact with an acid or basic pickling bath and is specific to the (co)polymers to be metallized. It provides surface roughness and very generally surface oxidation. Every time, the pickling, also called <<satin-finishing>>, will degrade at the surface the (co)polymer making up the surface of the substrate or the substrate to be treated by chemical etching. This pickling follows the laws of chemical reactivity of polymeric chains.

Indeed, this degradation causes breakage of the (co)polymer chains at the surface, consequently causing their solubilization so as to cause occurrence of roughness at the surface of the (co)polymer. As examples, acid etching on polymers of the polyamide type allows degradation of the organic material. In the same way, basic etching allows degradation and dissolution of the polycarbonate contained at the surface in ABS-PC, increasing the surface roughness. These acid-basic treatments therefore provide roughness and oxidation.

As an example of a pickling bath, mention may be made of an acid aqueous solution comprising at least one inorganic acid. Said inorganic acid is notably selected from the group consisting of chromic acid, sulfuric acid, nitric acid, hypochlorous acid and mixtures thereof. By <<mixture>>, is meant a mixture of at least two different inorganic acids such as a mixture of chromic acid and sulfuric acid or a mixture of at least three different inorganic acids such as a mixture of nitric acid, hypochlorous acid and sulfuric acid.

The chemical pretreatment is advantageously carried out for a duration comprised between 1 and 60 mins, notably between 2 and 30 mins and, in particular between 5 and 20 mins and at a temperature comprised between 20 and 120° C., notably between 40 and 110° C. and, in particular, between 60 and 100° C.

The surface to be treated may also be subject to pretreatment via a dry route. Such physico-chemical treatments comprising a flame treatment, a corona effect treatment and a plasma treatment also have a dual effect; i) oxidation of the chemical bonds at the surface and ii) increase in the roughness.

The flame treatment also called <<flaming>> consist in exposing the surface of the substrate and/or the substrate to the action of a flame and notably to the action of a stable and slightly oxidizing flame. The high temperatures of this treatment generate active species which may correspond to radicals, ions or excited molecules. The (co)polymer making up the surface of the substrate and/or the substrate is oxidized over a thickness of the order of 4 to 9 mm. At the surface, functional groups are fixed of the carboxylic (—COOH), hydroxyl (—OH), carbonyl (—C═O), amine (—NH₂), nitrile (—CN) and sometimes amide (—CONH) type. A phenomenon of diffusion of chemical species inside the polymer stemming from its degradation is observed. There is a real restructuration of the surface. These modifications are expressed by an improvement in the wettability and the roughness of the surface to be coated.

The flame is notably positioned at a distance from the surface of the substrate and/or from the substrate comprised between 0.1 and 20 cm, in particular between 0.3 and 10 cm and, more particularly, between 0.5 and 5 cm.

This flame is advantageously generated by a mixture of at least two gases, the first and the second gas being selected from the group consisting of hydrogen, methane, ethane and propane and the group consisting of air, ozone and oxygen respectively. The temperature of the thereby obtained flame is comprised between 500 and 1,600° C., notably between 800 and 1,400° C. and, in particular on the order of 1,200° C. (i.e. 1,200±100° C.)

The duration of the flame treatment is comprised between 0.01 and 10 s, notably between 0.015 and 1 s, and in particular between 0.02 and 0.1 s.

The corona effect treatment is also called <<a treatment by the corona effect>> or <<treatment by a corona discharge>> and consists in exposing the surface of the substrate and/or the substrate to an ionization field generated by having a high voltage AC current pass between two electrodes distant by a few millimeters and notably by 1 to 2 mm. Thus, an electric discharge caused by the ionization of the medium surrounding a conductor occurs when the electric potential exceeds a critical value and when the conditions do not allow the formation of an arc.

During this ionization, the emitted electrons are precipitated into the electric field and transmit their energy to the molecules of the medium surrounding the surface of the substrate and/or the substrate which is advantageously air or inert gas optionally enriched with oxygen. This causes dehydrogenation and breakage of chains of the (co)polymer(s) of the substrate as well as spontaneous reactions with the chemical species present in the medium. The surface of the (co)polymer forming the surface of the substrate and/or the substrate is oxidized.

The density of the corona discharge is advantageously comprised between 10 and 500 W·min/m², notably between 20 and 400 W·min/m² and, in particular between 30 and 300 W·min/m².

The duration of the treatment by the corona effect is comprised between 0.1 and 600 s, notably between 1 and 120 s, and, in particular between 10 to 50 s.

The plasma treatment consists of exposing the surface of the solid support and/or the solid support to a plasma.

As a reminder, a plasma is a gas in the ionized state, conventionally considered as a fourth state of matter. The energy required for ionization of a gas is brought by means of an electromagnetic wave (radio frequency or microwave). The plasma consists of neutral molecules, of ions, of electrons, of radical species (chemically highly active) and of excited species which will react with the surface of the material. If the plasmagen gas contains oxygen or nitrogen, these atoms will instantaneously react with the surface of the (co)polymer and generate active sites thereon. Modification of the (co)polymers by plasmas is expressed by the formation of radicals and of double bonds, by cross-linking and functionalization of the surface. Plasma treatment is usually limited to the outermost surface and the provided surface roughness is limited.

A distinction is made between so-called <<cold>> plasmas and so-called <<hot>> plasmas which are distinguished from each other as regards the ionization rate of the species contained in the plasma. For so-called <<cold>> plasmas, the ionization rate of the reactive species is less than 10⁻⁴ while for so-called <<hot>> plasmas, it is greater than 10⁻⁴. The terms of <<hot>> and <<cold>> come from the fact that the so-called <<hot>> plasma is much more energetic than the so-called <<cold>> plasma. In the case of a pretreatment within the scope of the method according to the invention, a so-called <<cold>> plasma is more suitable. The plasma is advantageously generated by one or several plasmagen gas(es). In the case when the plasmagen gas is a mixture of at least two gases, the first and the second gas are respectively selected from the group consisting of inert gases and the group consisting of air and oxygen.

The duration of the plasma treatment is comprised between 1 s and 5 mins, notably between 10 and 60 s, and, in particular between 20 and 40 s.

Within the scope of the method according to the present invention, it may be necessary between two treatment steps; prior to step (a); between steps (a) and (b) or between steps (b₁) and (b₂), to subject the surface of the substrate and/or the substrate to rinsing or several rinsings applying either identical or different rinsing solutions.

Any rinsing solution known to one skilled in the art may be used. Advantageously, this rinsing solution is selected from water, distilled water, deionized water, MilliQ water, an aqueous solution containing a detergent such as TDF4 or sodium hydroxide, notably sodium hydroxide at a concentration comprised between 0.01 and 1 M. The rinsing solution, when it is put into contact with the surface of the substrate or the substrate may notably be stirred by using a stirrer, a magnetic bar, an ultrasonic bath or a homogenizer. Each rinsing step may last for 1 to 30 mins and notably from 5 to 20 mins.

The present invention finally relates to a substrate, the surface of which is coated with a metal material which may be obtained by the method of the invention as defined earlier.

Other features and advantages of the present invention will further become apparent to one skilled in the art upon reading the examples given below as an illustration and not as a limitation, with reference to the appended figures.

### SHORT DESCRIPTION OF THE DRAWINGS

FIG. 1 shows the diagram for cyclic voltammetry on an ABS plate metallized with copper in an electroless way according to the method of the present invention.

FIG. 2 shows the diagram for cyclic voltammetry on an ABS-PC plate metallized with copper in an electroless way according to the method of the present invention.

FIG. 3 shows the diagram for cyclic voltammetry on a PA plate metallized with copper in an electroless way according to the method of the present invention.

FIG. 4 shows the diagram for cyclic voltammetry on an ABS plate metallized with copper in an electroless way according to the method of the present invention (Example II hereafter).

FIG. 5 shows the diagram for cyclic voltammetry on an ABS-PC plate metallized with copper in an electroless way according to the method of the present invention (Example III hereafter).

### DETAILED DISCUSSION OF PARTICULAR EMBODIMENTS

I. Metallization Via a Fenton Treatment of Plates of Acrylonitrile-Butadiene-Styrene (ABS), of Acrylonitrile-Butadiene-Styrene/Polycarbonate (ABS/PC) and of Polyamide (PA).

This metallization method is carried out in 3 steps (Fenton treatment/reduction/electroless metallization) and before treating the polymer, it should be prepared, degreased and cleaned.

I.1. Polishing

In a first phase, the plates are subject to polishing in order to minimize the effects of edges and other flaws provided during the cutting of the plates.

I.2. Rinsing

In a second phase, the plates are rinsed with an industrial soap solution TDF4 mixed with water (1 mL of TDF4 for 4 mL of MilliQ H₂O), with ultrasound for 10 mins. The plates are then rinsed with MilliQ water, with ultrasound for 10 mins.

I.3. Fenton Pretreatment

Iron(II) sulfate (6.961 g, 0.1 mol) was solubilized in 50 mL of 10⁻³ M sulfuric acid in water. The plates of polymers were immersed in this solution. 10 mL (0.124 mol) of 35% hydrogen peroxide in water were then added, dropwise. After 25 mins, the samples were rinsed with MilliQ water before being dried.

The results obtained for the contact angle measurements of a drop of 2 μl of water deposited on the samples treated according to the Fenton treatment <<After>>) or without any treatment (<<Virgin>>) are shown in Table 1 hereafter.

TABLE 1
Measurement of the contact angles of a drop

| | ABS | ABS/PC | PA |
|---|---|---|---|
| Virgin | 90° | 81.8° | 63.2° |
| After Fenton | 0-14° | 32.4° | 0-15° |

The contact angle is clearly lowered. The surface has become highly hydrophilic because of its oxidation.

The analysis of the IR spectra is shown in Table 2 hereafter.

TABLE 2
IR bands having appeared after Fenton oxidative treatment
on the samples

| Plates of | | | |
|---|---|---|---|
| polymers | ABS | ABS/PC | PA |
| After Fenton | 3600-3200 cm⁻¹ | 3600-3100 cm⁻¹ | 3600-3100 cm⁻¹ |
| | 1700-1640 cm⁻¹ | 1700-1640 cm⁻¹ | |
| | 1150-1100 cm⁻¹ | 1150-1100 cm⁻¹ | |

The appearance of bands at 3600-3200 cm⁻¹ and between 1150-1100 cm⁻¹ is typical of the provision of C—OH bonds. For ABS and ABS-PC, the 1700-1640 cm⁻¹ band may mean the appearance of amide groups from the oxidation of the nitrile groups of the polyacrylonitrile. Within the scope of polyamide, the 1150-1100 and 1700 bands coincide with the bands of the virgin polymer.

XPS analysis of the ABS plate before/after Fenton treatment shows a provision of Fe²⁺/Fe³⁺ and strong oxidization of the surface by a provision of oxygen. The atomic ratios relatively to the carbon signal are shown in Table 3 hereafter.

TABLE 3
Ratio of the intensities obtained with XPS analysis of the different
elements relatively to electrons from the 1s layer of carbon.

Intensity ratio X/C1s

| Electrons | Virgin ABS | Fenton ABS |
|---|---|---|
| C1s | 1 | 1 |
| O1s | 0.028 | 1.130 |
| N 1s | 0.097 | 0.049 |
| Fe 2p3/2 | 0 | 0.141 |
| Fe 2p1/2 | 0 | 0.122 |
| B 1s | 0 | 0 |
| S 2p | 0 | 0.132 |

I.4. Reduction of the ferric/ferrous ions

Sodium borohydride NaBH₄ (0.316 g, 0.8×10⁻² mol) is dissolved in 25 mL of a 0.1 M sodium hydroxide solution (NaOH). This solution is heated to 80° C. by means of a water bath and the samples are immersed therein. After 12 mins the samples were rinsed with MilliQ water before being dried.

IR analysis reveals preservation of the oxidation obtained after Fenton with the 3600-3100 cm⁻¹ bands and the 1700-1640 cm⁻¹ bands, regardless of the polymer.

XPS analysis of the ABS plate before/after reduction shows a slight decrease in all the elements except for the boron occurrence. According to the XPS spectra, the latter is in an oxidized form and thereby confirms reduction of the Fe²⁺/Fe³⁺ ions by the borohydride BH₄⁻. Iron as for it is oxidized in air and water before the XPS analysis and appears in oxidized form. The atomic ratios relatively to the carbon signal are shown in Table 4 hereafter.

TABLE 4
Ratio of the intensities obtained in XPS analysis of the different
elements relatively to the electrons of the 1s layer of carbon

Intensity ratio X/C1s

| Electrons | Fenton ABS | Fenton ABS + Reduction |
|---|---|---|
| C1s | 1 | 1 |
| O1s | 1.130 | 0.860 |
| N 1s | 0.049 | 0.027 |
| Fe 2p3/2 | 0.141 | 0.124 |
| Fe 2p1/2 | 0.122 | 0.108 |
| B 1s | 0 | 0.088 |
| S 2p | 0.132 | 0.116 |

I.5. Electroless Copper Metallization Bath

The samples are immersed in the solution described in Table 5 hereafter, heated to 40° C. in a water bath:

TABLE 5
Composition of the copper metallization bath
Metallization bath

| Reagents | m(g) for 100 mL | C (g/l) |
|---|---|---|
| CuSO₄, 7H₂O | 0.5 | 5 |
| Disodium | 2.96 | 25 |
| Tartarate | | |
| C₄H₄Na₂O₆ | | |
| NaOH | 0.5 | 7 |
| Formaldehyde | 2.94 | 10 mL/L |
| HCHO (37% in | | |
| H₂O) | | |

After 15 mins, the samples were rinsed with MilliQ water, with ultrasound for 10 mins before being dried.

The infrared analysis reveals the disappearance of the peaks of the different polymers.

XPS analysis confirms the presence of a metal copper layer (in its reduced form)Cu°. The atomic ratios relatively to the carbon signal are shown in Table 6 hereafter.

TABLE 6
Ratio of the intensities obtained in XPS analysis of the different
elements relatively to the electrons of the 1s layer of carbon.

Intensity ratio X/C1s

| Electrons | Fenton ABS + Reduction | ABS after metallization |
|---|---|---|
| C1s | 1 | 1.000 |
| O1s | 0.860 | 0.501 |
| N 1s | 0.027 | 0.030 |
| Fe 2p3/2 | 0.124 | 0 |
| Fe 2p1/2 | 0.108 | 0 |
| B 1s | 0.088 | 0 |
| S 2p | 0.116 | 0 |
| Cu 2p3/2 | 0 | 0.816 |
| Cu 2p1/2 | 0 | 0.713 |

The copper layer is also visible to the naked eye. The presence of carbon, nitrogen and oxygen after metallization is due to the presence of organic impurities at the outermost surface of the metallized substrate. Oxygen may also stem from the oxidation with air of the copper layer before the analysis.

I.6. Depositing Copper by Electrodeposition

In order to confirm the presence of a metal layer, copper was deposited by electrodeposition. This technique is only possible in the presence of conducting substrates.

Thus, the ABS, ABS-PC and PA plates having been subject to metallization with copper were used, in turn, as a measurement electrode. The electrochemical system set into place consisted of a calomel reference electrode with saturated KCl and of a counter-electrode in graphite.

The electrodes were soaked in a 10 g/l CuSO₄ solution, the initial potential being about 0.1 V.

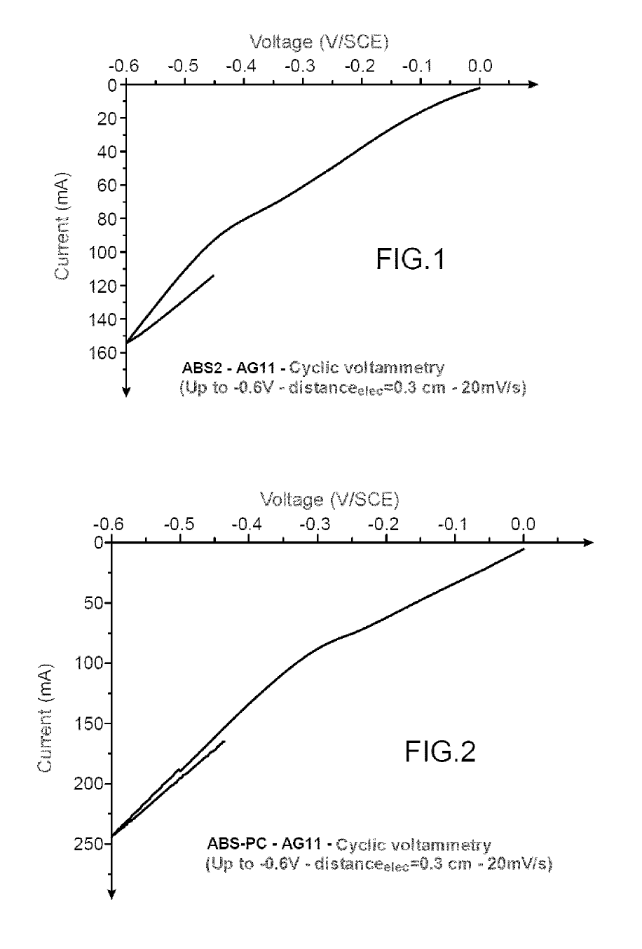

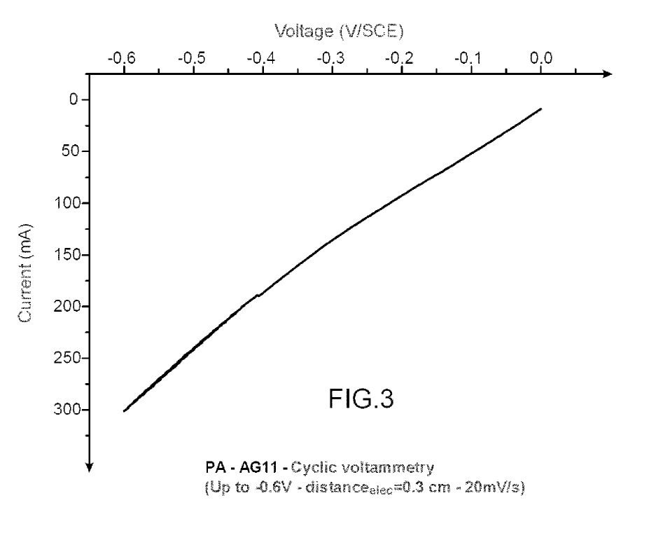

A voltammetry cycle ranging up to −0.6 V within 30 s was imposed to the system. During the voltage rise, the experiment was stopped around −0.45 V (FIGS. 1, 2 and 3).

This cycle demonstrated the deposition of copper on the measurement electrode. Indeed, the current increased when the voltage decreased and copper was deposited on the plates acting as a measurement electrode. Reduction of the copper occurred at the measurement electrode.

Confirmation of the copper deposit is also a visual confirmation. Indeed, the copper layer deposited by electrochemistry has a slightly more homogeneous aspect.

II. Metallization Via Pretreatment Accompanied by a Fenton Treatment of ABS Plates.

This metallization method is carried out in 4 steps (Oxidizing Treatment/Fenton Treatments/Reduction/Electroless Metallization) and before treating the polymer, it should be prepared, degreased and cleaned.

II.1. Polishing

In a first phase, the plates are subject to polishing in order to minimize the effects of edges and of other flaws provided during the cutting of the plates.

II.2. Rinsing

In a second phase, the plates are rinsed with an industrial soap solution TDF4 mixed with water (1 mL of TDF4 for 4 mL MilliQ H₂O), with ultrasound for 10 mins. The plates are then rinsed with MilliQ water, with ultrasound for 10 mins.

II.3. Acid Pretreatment

The plates are immersed for 10 mins in a 60% nitric acid solution at a temperature of 60° C. The plates are then rinsed in a (0.1 M) NaOH solution with ultrasound for 10 mins and then with MilliQ water with ultrasound for 10 mins.

The results obtained for the contact angle measurements of a drop of 2 μl of water deposited on the samples treated according to the Fenton treatment (<<After>>) or without any treatment (<<Virgin>>) are shown in Table 7 hereafter.

TABLE 7
Measurement of the contact angles of a drop

| | ABS |
|---|---|
| Virgin | 90° |
| After acid | 67° |
| pretreatment | |

The contact angle is lowered. The surface has become more hydrophilic because of its oxidation and the surface roughness has increased.

The analysis of the IR spectra is shown in Table 8 hereafter.

TABLE 8
IR bands having appeared after the acid pretreatment

| Plates of polymers | ABS |
|---|---|
| After acid treatment | 3600-3200 cm⁻¹ |
| | 1660-1610 cm⁻¹ |
| | 1570-1530 cm⁻¹ |
| | 1320-1280 cm⁻¹ |

The appearance of the 3600-3200 cm⁻¹ and 1660-1610 cm⁻¹ bands may be due to the presence of trace amounts of water.

On the other hand, the 1570-1530 cm⁻¹ and 1320-1280 cm⁻¹ bands are characteristic of carbonyl groups, of the carboxylate type COO⁻. This confirms surface oxidation.

II.4. Fenton Pretreatment

Iron(II) sulfate (6.961 g, 0.1 mol) was solubilized in 50 mL of 10⁻³ M sulfuric acid in water. The plates of polymers were immersed in this solution. 10 mL (0.124 mol) of 35% hydrogen peroxide in water were then added, dropwise. After 25 mins, the samples were rinsed with MilliQ water before being dried.

The results obtained for the contact angle measurements of a drop of 2 μl of water deposited on the samples treated according to the Fenton treatment <<After Fenton>>) or before treatment (<<After acid treatment>>) are shown in Table 9 hereafter.

TABLE 9
Measurement of the contact angles of a drop

| | ABS |
|---|---|
| After acid | 67° |
| treatment | |
| After Fenton | 0-5° |

The contact angle is clearly lowered. The surface has become highly hydrophilic because of its oxidation.

The analysis of the IR spectra is shown in Table 10 hereafter.

TABLE 10
IR bands having appeared after Fenton oxidative treatment on the samples

| Plates of polymers | ABS |
|---|---|
| After Fenton | 3600-3200 cm⁻¹ |
| | 1700-1600 cm⁻¹ |
| | 1320-1280 cm⁻¹ |
| | 1150-1100 cm⁻¹ |

The amplification of the 3600-3200 cm⁻¹ band after Fenton treatment as well as the appearance of the band between 1150-1100 cm⁻¹ are typical of the provision of C—OH bonds. The appearance of the band at 1700-1600 cm⁻¹ and the amplification of the 1320-1280 cm⁻¹ band confirmed the presence of carbonyl groups at the surface of the ABS plates.

II.5. Reduction of the Ferric/Ferrous Ions

Sodium borohydride NaBH₄ (0.316 g, 0.8 10⁻² mol) is dissolved in 25 mL of a 0.1 M sodium hydroxide (NaOH) solution. This solution is heated to 80° C. with a water bath and samples are immersed therein. After 12 mins, the samples were rinsed with MilliQ water before being dried.

IR analysis reveals preservation of the oxidation obtained after Fenton with 3600-3200 cm⁻¹ bands and 1700-1640 cm⁻¹ bands.

II.6. Copper Electroless Metallization Bath

The samples are immersed in a commercial electroless metallization bath (M Copper 85, MacDermid) with formaldehyde as a reducing agent. Nevertheless, the plates are immersed therein for 10 mins at 48° C.

After 10 mins, the samples were rinsed with MilliQ water, with ultrasound for 10 mins before being dried.

Infrared analysis reveals the disappearance of the peaks of the different polymers.

The copper layer is visible to the naked eye.

II.7 Scotch™ Tape Test

In order to check the mechanical strength of the layers which have been grafted earlier, a test with an adhesive tape was carried out. It consists of sticking on the layer, a piece of adhesive tape and then of removing it from the layer.

If the deposited layer is carried away with the adhesive, the mechanical strength is considered as poor. If the layer remains insensitive to the adhesive, the mechanical strength is considered as good.

The adhesive tape which was used is a high performance invisible adhesive tape of the PROGRESS brand.

This test was carried out on an ABS plate after the metallization with every time a portion pretreated with acid and a non-pretreated portion. Metallization is homogeneous. The results of this test show better strength on the pretreated portion.

II.8. Depositing Copper by Electrodeposition

In order to confirm the presence of a metal layer, copper was deposited by electrodeposition. This technique is only possible in the presence of conducting substrates.

Thus, an ABS plate having undergone copper metallization was used as a measurement electrode. The electrochemical system set into place consisted of a calomel reference electrode with saturated KCl of a counter-electrode in graphite.

The electrodes were soaked in a 10 g/L CuSO₄ solution, the initial potential was about 0 V.

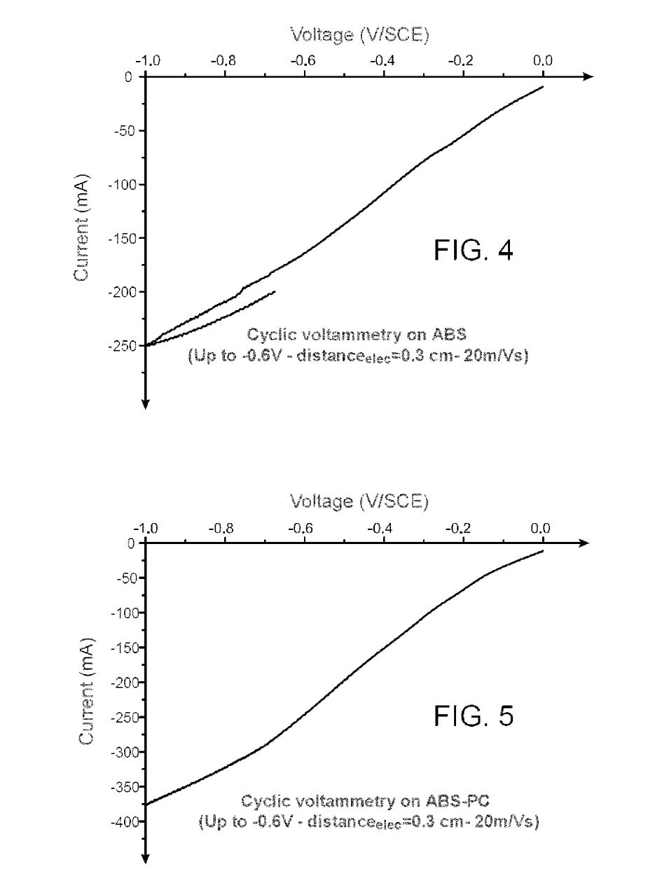

A voltammetry cycle ranging up to −1 V in 30 s was imposed to the system. During the rise in voltage, the experiment was stopped around −0.75 V (FIG. 4).

This cycle demonstrated the deposition of copper on the measurement electrode. Indeed, the current increased when the voltage decreased and copper was deposited on the plates acting as a measurement electrode. Reduction of the copper occurred at the measurement electrode.

Confirmation of the deposition of copper is also a visual confirmation. Indeed, the copper layer deposited by electrochemistry has a slightly more homogeneous aspect.

III. Metallization Via a Pretreatment Accompanied by a Fenton Treatment of ABS-PC Plates.

This metallization method is carried out in 4 steps (Oxidizing Pretreatment/Fenton Treatment/Reduction/Electroless Metallization) and before treating the polymer, it should be prepared, degreased and cleaned.

III.1. Polishing

In a first phase, the plates are subject to polishing in order to minimize the effects of edges and of other flaws provided during the cutting of the plates.

III.2. Rinsing

In a second phase, the plates are rinsed with an industrial soap solution TDF4 mixed with water (1 mL of TDF4 for 4 mL of MilliQ H₂O), with ultrasound for 10 mins. The plates are then rinsed with MilliQ water, with ultrasound for 10 mins.

III.3. Acid Pretreatment

The plates are immersed for 10 mins in a 30% by mass NaOH solution at a temperature of 90° C. The plates are then rinsed in a 0.5 M HCl solution with ultrasound for 10 mins and then with MilliQ water with ultrasound for 10 mins.

The results obtained for the contact angle measurements of a drop of 2 μl of water deposited on the samples treated according to the Fenton treatment (<<After>>) or without treatment (<<Virgin>>) are shown in Table 11 hereafter.

TABLE 11
Measurement of the contact angles of a drop

| | ABS-PC |
|---|---|
| Virgin | 90° |
| After acid | 67° |
| pretreatment | |

The contact angle is lowered. The surface has become more hydrophilic because of its oxidation and the surface roughness has increased.

Analysis of the IR spectra is shown in Table 12 hereafter.

TABLE 12
IR bands having appeared after the acid pretreatment

| Plates of polymers | ABS-PC |
|---|---|
| After basic | 3600-3200 cm⁻¹ |
| treatment | 1660-1610 cm⁻¹ |
| | 1740-1700 cm⁻¹ |
| | 1320-1280 cm⁻¹ |

The appearance of bands at 3600-3200 cm⁻¹ and 1660-1610 cm⁻¹ may be due to the presence of trace amounts of water. On the other hand, the bands at 1740-1700 cm⁻¹ and at 1320-1280 cm⁻¹ are characteristic of carbonyl groups, of the carboxylic COOH type. This confirmed surface oxidation. On the other hand, the disappearance of the ester band at 1772 cm⁻¹ characteristic of polycarbonate is observed.

III.4. Fenton Pretreatment

Iron(II) sulfate (6.961 g, 0.1 mol) was solubilized in 50 mL of 10⁻³ M sulfuric acid in water. The plates of polymers were immersed in this solution. 10 mL (0.124 mol) of 35% hydrogen peroxide in water were then added, dropwise. After 25 mins, the samples were rinsed with MilliQ water before being dried.

The results obtained for the contact angle measurements of a drop of 2 μl of water deposited on the samples treated according to the Fenton treatment(<<After Fenton>>) or before treatment (<<after basic treatment>>) are shown in Table 13 hereafter.

TABLE 13
Measurement of the contact angles of a drop

| | ABS-PC |
|---|---|
| After basic | 67° |
| treatment | |
| After Fenton | 0-5° |

The contact angle is clearly lowered. The surface has become highly hydrophilic because of its oxidation.

The analysis of IR spectra is shown in Table 14 hereafter.

TABLE 14
IR bands having appeared after Fenton oxidative treatment on the samples

| Plates of polymers | ABS-PC |
|---|---|
| After Fenton | 3600-3200 cm⁻¹ |
| | 1700-1600 cm⁻¹ |
| | 1320-1280 cm⁻¹ |
| | 1150-1100 cm⁻¹ |

The amplification of the 3600-3200 cm⁻¹ band after Fenton treatment as well as the appearance of the band between 1150-1100 cm⁻¹ are typical of the provision of C—OH bonds. The appearance of bands at 1700-1600 cm⁻¹ and the amplification of the 1320-1280 cm⁻¹ band confirm the presence of carbonyl groups at the surface of the ABS-PC plates.

III.5. Reduction of Ferric/Ferrous Ions

Sodium borohydride NaBH₄ (0.316 g, 0.8 10⁻² mol) is dissolved in 25 mL of a 0.1 M sodium hydroxide (NaOH) solution. This solution is heated to 80° C. by means of a water bath and the samples are immersed therein. After 12 mins, the samples were rinsed with MilliQ water before being dried.

IR analysis reveals preservation of the oxidation obtained after Fenton with the 3600-3200 cm⁻¹ bands and the 1700-1640 cm⁻¹ bands.

III.6. Copper Electroless Metallization Bath

The samples are immersed in a commercial electroless metallization bath (M Copper 85, MacDermid) with formaldehyde as a reducing agent. The exact composition of the copper bath is not known. Nevertheless, the plates are immersed therein for 10 mins at 48° C.

After 10 mins, the samples were rinsed with MilliQ water, with ultrasound for 10 mins before being dried.

Infrared analysis reveals the disappearance of the peaks of the different polymers.

The copper layer is visible to the naked eye.

III.7. Deposition of Copper by Electrodeposition

In order to confirm the presence of a metal layer, copper was deposited by electrodeposition. This technique is only possible in the presence of conducting substrates.

Thus, an ABS-PC plate having undergone metallization with copper was used as a measurement electrode. The electrochemical system set into place consisted of a calomel reference electrode with saturated KCl and of a counter-electrode in graphite.

The electrodes were soaked in a 10 g/L CuSO₄ solution, the initial potential was about 0 V.

A voltammetry cycle ranging up to −1 V in 30 s was imposed to the system. During the rise in voltage, the experiment was stopped around −0.75 V (FIG. 5).

This cycle showed the copper deposit on the measurement electrode. Indeed, the current increased when the voltage decreased and the copper was deposited on the plates acting as a measurement electrode. Reduction of the copper occurred at the measurement electrode.

Confirmation of the copper deposit is also a visual confirmation. Indeed, the copper layer deposited by electrochemistry has a slightly more homogeneous aspect.

### REFERENCES

[1] Charbonnier, M., et al., “Plasma treatment process for palladium chemisorption onto polymers before electroless deposition”, Journal of the Electrochemical Society 1996, 143, (2), 472-480.
[2] Patent application CA 1 203 720 in the name of OMI Int. Corp. published on Apr. 29, 1986.
[3] Naudin, <<Nomenclature, classification et formules chimiques des polymères>> Techniques de l'Ingénieur 1995: A3035.

1. A method for coating a surface of a substrate in (co)polymer with a metal material comprising the successive steps of:
a) subjecting said surface to an oxidizing treatment by a chemical reaction of the Fenton type in the presence of at least one precursor of said metal material; and
b) transforming said precursor into said metal material.

2. The method according to claim 1, wherein said substrate is selected from the group consisting of a nanoparticle, a microparticle, a button, a plug of cosmetic products, an electronic element, a door handle, a home electric appliance, glasses, a decorative object and a vehicle body element.

3. The method according to claim 1 wherein said (co)polymer is selected from the group consisting of acrylonitrile-butadiene-styrene (ABS), acrylonitrile-butadiene-styrene/polycarbonate (ABS/PC), a polyamide (PA), a polyamine, a poly(acrylic acid), a polyaniline and a polyethylene terephthalate (PET).

4. The method according to any of claim 1, wherein the oxidizing treatment of said step (a) consists in putting said surface of the substrate in contact with a solution containing at least one precursor of the metal material and a compound of formula ROOR in which R represents a hydrogen, an alkyl group comprising from 1 to 15 carbon atoms, an acyl group —COR′ with R′ representing an alkyl group comprising from 1 to 15 carbon atoms or an aroyl group —COAr with Ar representing an aromatic group comprising from 6 to 15 carbon atoms.

5. The method according to claim 4, wherein said solution comprising at least one precursor of the metal material and a compound of formula ROOR is an acid solution.

6. The method according to claim 1, wherein said precursor of the metal material is selected from the group consisting of copper, silver, gold, iron, ruthenium, osmium, cobalt, rhodium, iridium, nickel, palladium and platinum ions.

7. The method according to claim 1, wherein said step (b) has successive sub steps consisting in of:
b₁) optionally reducing said precursor of the metal material present at the surface of said substrate; and
b₂) putting into contact said precursor optionally reduced following step (b₁) in a solution containing at least one ion of the metal material.

8. The method according to claim 7, wherein the ion(s) of the metal material is(are) selected from the group consisting of Ag⁺, Ag²⁺, Ag³⁺, Au⁺, Au³⁺, Co²⁺, Cu⁺, Cu²⁺, Fe²⁺, Ni²⁺, Pd⁺ and Pt⁺.

9. The method according to claim 1, wherein the surface of the substrate is subject, prior to said step (a) of the method, to a treatment capable of increasing its hydrophilicity and/or its roughness, said treatment being selected from the group consisting of sanding, abrasion, chemical treatment with a pickling bath, flame treatment, corona effect treatment and plasma treatment and combinations thereof.

10. The method according to claim 9, wherein said pickling bath is an acid aqueous solution comprising at least one inorganic acid notably selected from the group consisting of chromic acid, sulfuric acid, nitric acid, hypochlorous acid and mixtures thereof.
